(19) United States
(12) Patent Application Publication
(10) Pub. No.: US 2017/0058485 A1
(43) Pub. Date: Mar. 2, 2017

(54) HYBRID WORK VEHICLE

(71) Applicant: KOMATSU LTD., Tokyo (JP)

(72) Inventors: Hayao YOSHINO, Komatsu-shi, Ishikawa (JP); Takashi SUGIGUCHI, Neyagawa-shi, Osaka (JP); Akira YAMATO, Hirakata-shi, Osaka (JP)

(21) Appl. No.: 14/909,541

(22) PCT Filed: Aug. 24, 2015
(86) PCT No.: PCT/JP2015/073678

§ 371 Date: Feb. 2, 2016

(51) Int. Cl. E02F 9/08; B60K 1/00; B60K 11/04

(52) U.S. Cl. CPC E02F 9/0866; B60K 11/04; E02F 9/0883; B60K 1/00; E02F 3/32

(57) ABSTRACT

A hydraulic excavator is provided with an electric motor, an electrical equipment, a cooling fan, a partitioning member, and a cooling unit. The electrical equipment is connected electrically to the electric motor. The cooling fan generates cooling air. The partitioning member forms a ventilation path for guiding the cooling air. The cooling unit is arranged so as to block the ventilation path. The cooling unit has first and second cooling devices. The first cooling device cools a cooling medium for the electrical equipment. The second cooling device is arranged laterally to the first cooling device.

### CROSS-REFERENCE TO RELATED APPLICATIONS

This application is a U.S. National stage application of International Application No. PCT/JP2015/073678, filed on Aug. 24, 2015.

### BACKGROUND

Field of the Invention

The present invention relates to a hybrid work vehicle.

Background Information

Recently, a hybrid work vehicle has been proposed that travels using driving power from an engine and driving power from an electric motor. The hybrid work vehicle is provided with a radiator (referred to below as “electrical equipment radiator”) for cooling an electrical equipment, such as an inverter, in addition to conventional cooling devices, such as an engine radiator, an oil cooler, and an after-cooler.

FIG. 8 is a rough plan view illustrating an arrangement of a conventional electrical radiator. As illustrated in FIG. 8, an engine radiator 132, an oil cooler 133, and an after-cooler 134 are arranged horizontally in a line and an electrical equipment radiator 131 is arranged in front of the other radiators in the conventional hybrid work vehicle.

### SUMMARY

There is a desire to improve the cooling efficiency of a cooling medium for an electrical equipment radiator in the hybrid work vehicle as described above.

An object of the present invention is to improve the cooling efficiency of a cooling medium for an electrical equipment radiator.

### Solution to Problem

A hybrid work vehicle according to a first aspect of the present invention is provided with an electric motor, an electrical equipment, a fan, a partitioning member, and a cooling unit. The electrical equipment is connected electrically to the electric motor. The fan generates cooling air. The partitioning member forms a ventilation path for guiding the cooling air. The cooling unit has a first cooling device and a second cooling device. The first cooling device cools a cooling medium for cooling at least one of the electric motor and the electrical equipment. The second cooling device is arranged laterally to the first cooling device. The cooling unit is arranged to block the ventilation path.

The conventional electrical equipment radiator 131 is arranged separately on the upstream side of the cooling air with respect to the other radiators as illustrated in FIG. 8. When the electrical equipment radiator 131 is arranged in this way, the inventor of the present invention discovered that the outside air flows through a region in which the electrical equipment radiator 131 is not arranged and flows downstream of the electrical equipment radiator 131 to avoid the electrical equipment radiator 131 as in arrows A in FIG. 8. Conversely, the first cooling device according to exemplary embodiments of the present invention is arranged as a portion of the cooling unit that blocks the ventilation path guiding the cooling air. As a result, the outside air flows to pass through the cooling devices of the cooling unit. Consequently, a sufficient amount of the outside air passes through the first cooling device and the cooling efficiency of the cooling medium in the first cooling device can be improved. The ventilation path may not be completely blocked by the cooling unit.

The hybrid work vehicle preferably further has a third cooling device. The third cooling device is arranged on the downstream side of the cooling air with respect to the first cooling device. The first cooling device has a first inlet and a first outlet and the third cooling device has a second inlet and a second outlet. The first inlet is arranged in either of an upper part and a lower part of the first cooling device and faces the upstream side of the cooling air. The first outlet is arranged in the other of the upper part and the lower part of the first cooling device and faces the upstream side of the cooling air. The second inlet is arranged in either of an upper part and a lower part of the third cooling device and faces the downstream side of the cooling air. The second outlet is arranged in the other of the upper part and the lower part of the third cooling device and faces the downstream side of the cooling air. According to this configuration, piping between the first cooling device and the third cooling device can be installed efficiently.

The electrical equipment preferably is arranged on the upstream side of the cooling air with respect to the cooling units. The electrical equipment has a condenser for accumulating electrical power generated by the electric motor, and an inverter for changing the electrical power from direct current to alternating current. The long side of the inverter is shorter than the long side of the condenser. The inverter is arranged in a direction further away from the first cooling device in the long side direction of the inverter. According to this configuration, hindering of the cooling air by the inverter can be suppressed and a sufficient amount of outside air can be fed toward the first cooling device.

The hybrid work vehicle preferably further has a hydraulic fluid tank for storing hydraulic fluid. The third cooling device is an oil cooler for cooling the hydraulic fluid. The third cooling device has a first surface facing the first cooling device and a second surface facing the opposite side of the first surface. The hydraulic fluid tank is arranged on the side the second surface faces. According to this configuration, piping for connecting the hydraulic fluid tank and the third cooling device can be installed effectively.

The hybrid work vehicle preferably further has a control valve for controlling the flow rate of the hydraulic fluid. The control valve is arranged on the side the second surface faces. According to this configuration, piping for connecting the control valve and the third cooling device can be installed effectively.

The cooling unit preferably further has a filling member arranged between the first cooling device and the second cooling device. According to this configuration, a more sufficient amount of outside air can be fed to the cooling devices.

The cooling unit preferably further has a fourth cooling device arranged laterally to the second cooling device.

The second cooling device preferably is an engine radiator for cooling a cooling medium for the engine.

The hybrid work vehicle according to a second aspect of the present invention is provided with the electric motor, the electrical equipment, the fan, the first cooling device, and the third cooling device. The electrical equipment is connected electrically to the electric motor. The fan generates cooling air. The first cooling device cools a cooling medium for cooling at least one of the electric motor and the electrical equipment. The third cooling device is arranged on the downstream side of the cooling air with respect to the first cooling device. The first cooling device has a first inlet and a first outlet. The first inlet is arranged in either of an upper part and a lower part of the first cooling device and faces the upstream side of the cooling air. The first outlet is arranged in the other of the upper part and the lower part of the first cooling device and faces the upstream side of the cooling air. The third cooling device has a second inlet and a second outlet. The second inlet is arranged in either of an upper part and a lower part of the third cooling device and faces the downstream side of the cooling air. The second outlet is arranged in the other of the upper part and the lower bottom part of the third cooling device and faces the downstream side of the cooling air. According to this configuration, piping between the first cooling device and the third cooling device can be installed efficiently.

According to exemplary embodiments of the present invention, cooling efficiency of a cooling medium for an electrical equipment radiator can be improved.

### BRIEF DESCRIPTION OF DRAWINGS

FIG. 1 is a perspective view of a hydraulic excavator.

FIG. 2 is a plan view illustrating the inside of an engine compartment.

FIG. 3 is a front view of a cooling unit as seen from the upstream side of cooling air.

FIG. 4 is a block diagram illustrating the flow of a cooling medium cooled by the first cooling device.

FIG. 5 is a back view of the cooling unit as seen from the downstream side of the cooling air.

FIG. 6 is a side view illustrating the inside of the engine compartment.

FIG. 7 is a plan view illustrating the arrangement of various members.

FIG. 8 is a rough plan view illustrating an arrangement of an electrical equipment radiator in a conventional hydraulic excavator.

### DESCRIPTION OF EXEMPLARY EMBODIMENTS

A hydraulic excavator 100 is an exemplary embodiment of the work vehicle according to the present invention and is explained below with reference to the drawings. In the following explanation, “front” and “rear” refer to the front and the rear of a vehicle body 101. In the following description, “right,” “left,” “up,” and “down” indicate directions relative to a state of looking forward from the driver's seat. “Vehicle width direction” and “left-right direction” have the same meaning.

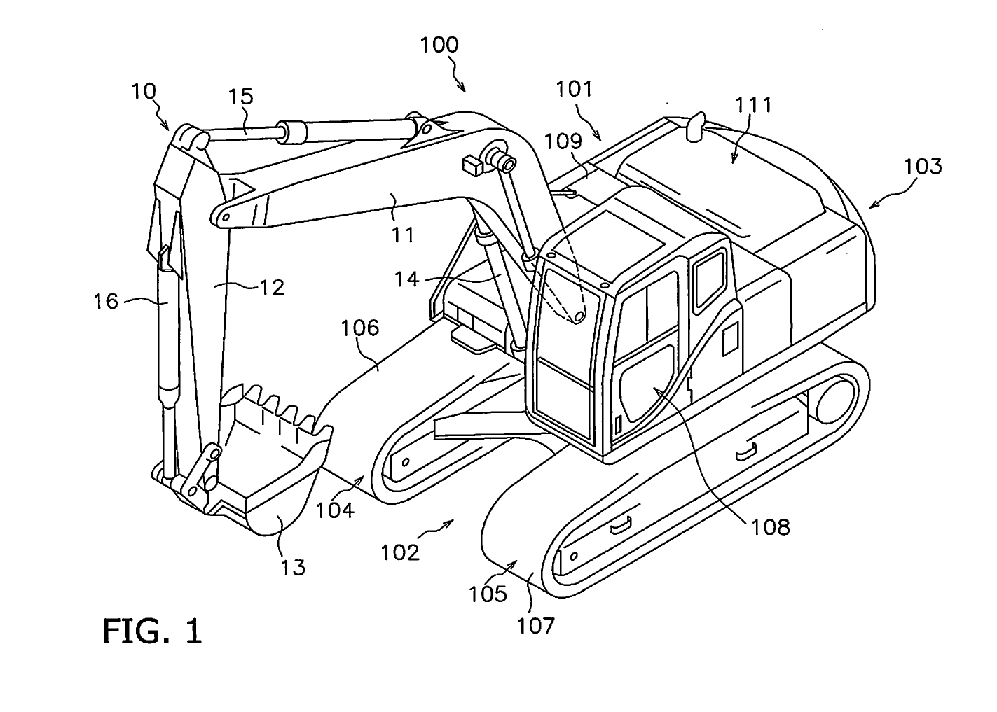

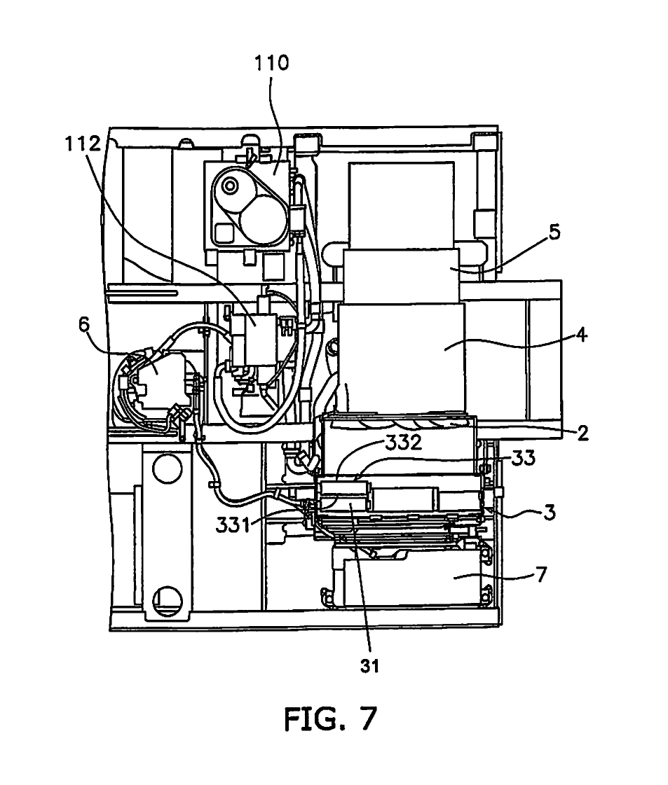

FIG. 1 is a perspective view of a hydraulic excavator 100. Referring to FIG. 1, the hydraulic excavator 100 is equipped with the vehicle body 101 and a work implement 10. The hydraulic excavator 100 carries out desired work using the work implement 10. The hydraulic excavator 100 is a hybrid-type hydraulic excavator and is provided with an engine 4, a generating electric motor 5, and a revolving electric motor 6 as described below (see FIG. 7). Energy produced in the hydraulic excavator 100 when decelerating the revolution of the vehicle body is converted to electrical energy by the revolving electric motor and accumulated in a condenser 71. The accumulated electrical energy is used via the generating electric motor 5 as supplemental energy during engine acceleration. The revolving electric motor 6 corresponds to the electric motor of the present invention.

The vehicle body 101 has an undercarriage 102 and a revolving superstructure 103. The undercarriage 102 includes a pair of travel devices 104 and 105. The travel device 104 has a crawler belt 106 and the travel device 105 has a crawler belt 107. The travel devices 104 and 105 enable the hydraulic excavator 100 to travel by obtaining driving power from the below-mentioned engine 4 and the generating electric motor 5 to drive the crawler belts 106 and 107.

The revolving superstructure 103 is mounted on the undercarriage 102, and is provided in a manner that allows revolving in relation to the undercarriage 102. The revolving superstructure 103 revolves in any direction due to the revolving electric motor 6. The revolving superstructure 103 has a cab 108, a fuel tank 109, a hydraulic fluid tank 110, and an engine compartment 111.

The fuel tank 109 stores fuel for driving the engine 4. The fuel tank 109 is arranged in front of the hydraulic fluid tank 110. The hydraulic fluid tank 110 stores hydraulic fluid. The hydraulic fluid tank 110 is arranged in a line in the front-back direction with the fuel tank 109. The fuel tank 109 and the hydraulic fluid tank 110 are arranged at one end part in the vehicle width direction, and the cab 8 is arranged in the other end part. In the present exemplary embodiment, the fuel tank 109 and the hydraulic fluid tank 110 are arranged in a right end part in the vehicle width direction, and the cab 8 is arranged in a left end part.

The engine compartment 111 is arranged to the rear of the cab 108, the fuel tank 109, and the hydraulic fluid tank 110. The engine compartment 111 is positioned in a rear part of the revolving superstructure 103. The engine compartment 111 extends in the vehicle width direction.

The work implement 10 is attached at the front of the revolving superstructure 103. The work implement 10 is driven by hydraulic fluid. The work implement 10 includes a boom 11, an arm 12, a bucket 13, a boom cylinder 14, an arm cylinder 15, and a bucket cylinder 16. The work implement 10 according to the present exemplary embodiment has a pair of boom cylinders 14.

The proximal end of the boom 11 is coupled to the revolving superstructure 103 in a rotatable manner. The proximal end of the arm 12 is coupled to the distal end of the boom 11 in a rotatable manner. The bucket 13 is coupled to the distal end of the arm 12 in a rotatable manner. The boom cylinders 14, the arm cylinder 15, and the bucket cylinder 16 are hydraulic cylinders and are driven by hydraulic fluid. The hydraulic cylinders 14 to 16 are driven by hydraulic fluid discharged from a hydraulic pump (not shown). The boom cylinders 14 actuate the boom 11. The arm cylinder 15 actuates the arm 12. The bucket cylinder 16 actuates the bucket 13. The work implement 10 is driven due to the driving of the cylinders 14 to 16.

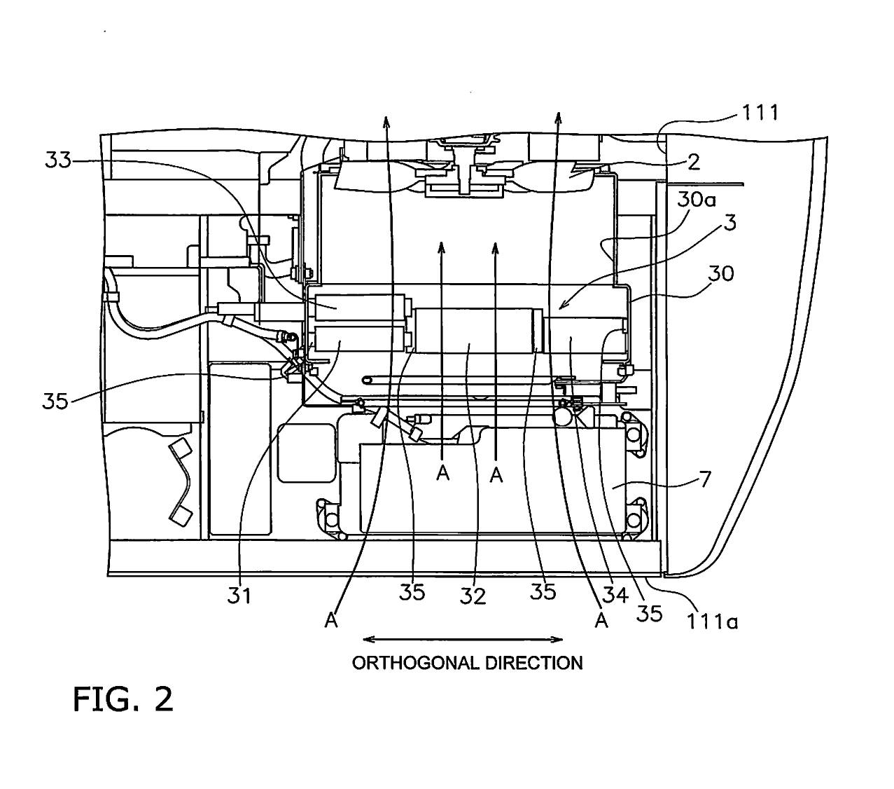

FIG. 2 is a plan view illustrating the inside of the engine compartment 111. As illustrated in FIG. 2, a cooling fan 2, a partitioning member 30, a cooling unit 3, the engine 4, the generating electric motor 5, the condenser 71, and an inverter 72 are housed inside the engine compartment 111. The engine compartment 111 is demarcated by a vehicle body cover 111a, an engine hood (not shown), and partition walls (not shown). The engine compartment 111 communicates with the outside via ventilation holes (not shown) formed in the vehicle body cover 111a.

The cooling fan 2 is configured to generate cooling air. The partitioning member 30 has a ventilation path 30a for guiding the cooling air. The partitioning member 30 is a plate and defines the ventilation path 30a. The cooling fan 2 is arranged at one end part of the ventilation path 30a. The cooling air generated by the cooling fan 2 flows through the ventilation path 30a. The ventilation path 30a extends in the flowing direction of the cooling air. The cooling fan 2 sucks outside air into the engine compartment 111 from the outside of the engine compartment 111 by rotating. The cooling air generated by the cooling fan 2 follows the vehicle width direction. The cooling air generated by the cooling fan 2 is made to flow straight inside the ventilation path 30a.

The cooling unit 3 is arranged to block the ventilation path 30a. The cooling unit 3 is arranged at the other end part of the ventilation path 30a. The cooling unit 3 blocks the ventilation path 30a at the other end part of the ventilation path 30a. The cooling unit 3 has a first cooling device 31, a second cooling device 32, a third cooling device 33, and a fourth cooling device 34. The cooling unit 3 further has filling members 35 for filling in gaps between the cooling devices. The filling members 35 are sponge sheets for example.

The first cooling device 31 is an electrical equipment radiator for cooling a cooling medium for the condenser 71 and the inverter 72. The cooling medium cooled by the first cooling device 31 also cools the revolving electric motor 6. The cooling medium for cooling the inverter 72 and the condenser 71 flows inside the first cooling device 31. The first cooling device 31 is arranged at an end part in the orthogonal direction orthogonal to the extending direction of the ventilation path 30a. The first cooling device 31 is arranged furthest toward the front of the vehicle among the members of the cooling unit 3. The filling member 35 is arranged between the first cooling device 31 and the partition plate 30a.

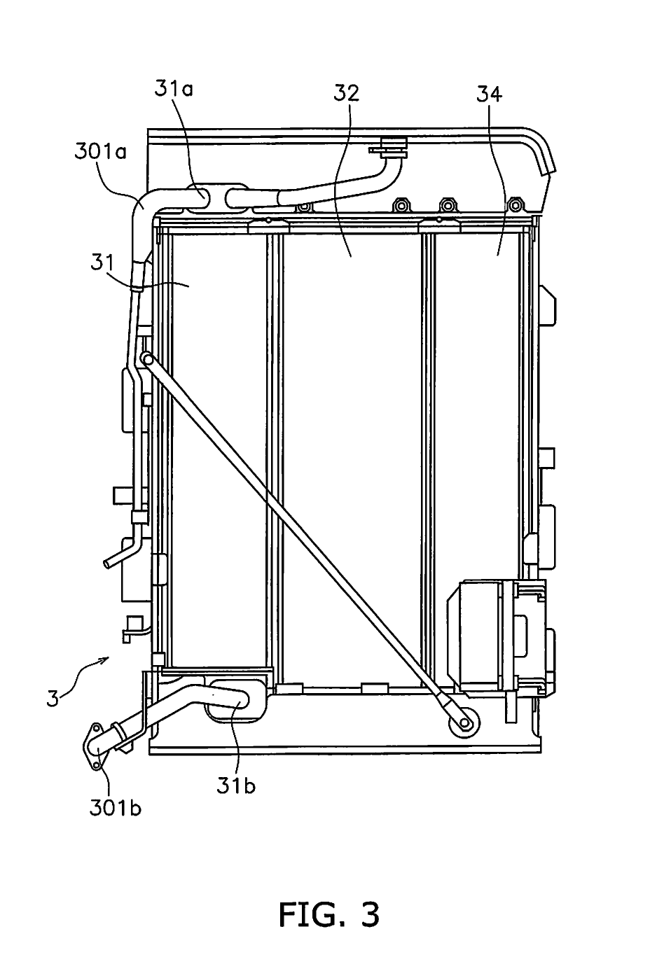

FIG. 3 is a front view of the cooling unit 3 as seen from the upstream side of the cooling air. As illustrated in FIG. 3, the first cooling device 31 has a first inlet 31a and a first outlet 31b. The cooling medium is fed into the first cooling device 31 via the first inlet 31a and discharged from the first cooling device 31 via the first outlet 31b. The first inlet 31a and the first outlet 31b face the upstream side of the cooling air. The first inlet 31a is positioned at an upper end part of the first cooling device 31 and the first outlet 31b is positioned at a lower end part of the first cooling device 31. A first supply pipe 301a is connected to the first inlet 31a, and a first discharge pipe 301b is connected to the first outlet 31b. The first supply pipe 301a and the first discharge pipe 301b connect a below-mentioned electrical equipment 7 and the first cooling device 31.

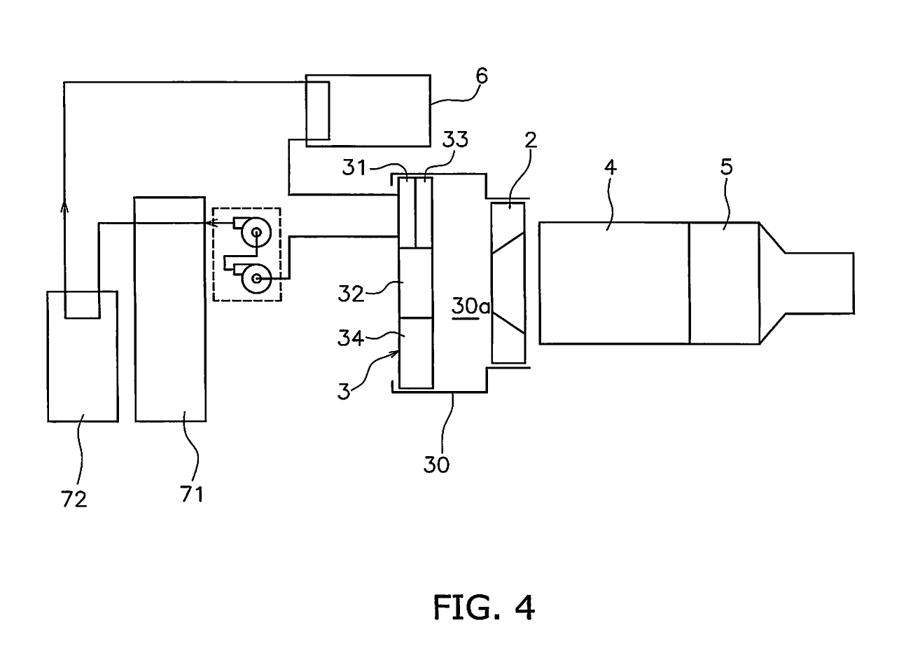

FIG. 4 is a block diagram illustrating the flow of the cooling medium cooled by the first cooling device 31. As illustrated in FIG. 4, the cooling medium cooled by the first cooling device 31 is supplied in order to the condenser 71, the inverter 72, and the revolving electric motor 6 and cools the condenser 71, the inverter 72, and the revolving electric motor 6.

As illustrated in FIG. 2, the third cooling device 33 is arranged to face the first cooling device 31. The third cooling device 33 is arranged on the downstream side of the cooling air with respect to the first cooling device. The third cooling device 33 is, for example, an oil cooler for cooling the hydraulic fluid.

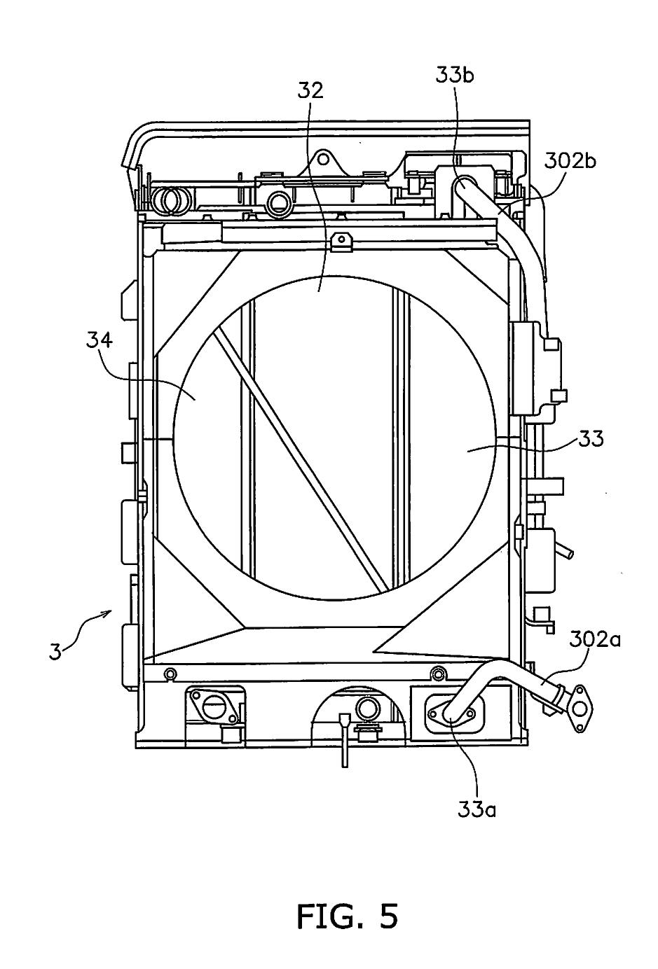

FIG. 5 is a back view of the cooling unit 3 as seen from the downstream side of the cooling air. As illustrated in FIG. 5, the third cooling device 33 has a second inlet 33a and a second outlet 33b. When the third cooling device 33 is an oil cooler, the hydraulic fluid is supplied into the third cooling device 33 via the second inlet 33a and discharged from the third cooling device 33 via the second outlet 33b. The second inlet 33a and the second outlet 33b face the downstream side of the cooling air. The second inlet 33a is positioned at a lower end part of the third cooling device 33 and the second outlet 33b is positioned at an upper end part of the third cooling device 33. A second supply pipe 302a is connected to the second inlet 33a, and a second discharge pipe 302b is connected to the second outlet 33b. The second supply pipe 302a connects the third cooling device 33 and a control valve 112, and the second discharge pipe 302b connects the third cooling device 33 and the hydraulic fluid tank 110.

As illustrated in FIG. 2, the second cooling device 32 is arranged laterally to the first cooling device 31. The second cooling device 32 is arranged laterally to the first cooling device 31 in an orthogonal direction substantially orthogonal to the extending direction of the ventilation path 30a. The orthogonal direction extends horizontally. In the present exemplary embodiment, the orthogonal direction is parallel to the vehicle front-back direction. The first cooling device 31 and the second cooling device 32 are aligned in the vehicle front-back direction. The second cooling device 32 is thicker than the first cooling device 31. The second cooling device 32 has a size greater than that of the first cooling device 31 in the extending direction of the ventilation path 30a. The second cooling device 32 is arranged on an extension line of the rotating shaft of the cooling fan 2. The wind receiving surface of the first cooling device 31 is arranged on substantially the same plane as the wind receiving surface of the second cooling device 32. The wind receiving surfaces of the cooling devices face the upstream side of the cooling air. The second cooling device 32 is, for example, an engine radiator for cooling the cooling medium for the engine. The filling members 35 are arranged between the second cooling device 32 and the first and third cooling devices 31 and 33.

The fourth cooling device 34 is arranged laterally to the second cooling device 32. The fourth cooling device 34 is arranged laterally to the second cooling device 32 in the orthogonal direction. The first cooling device 31, the second cooling device 32, and the fourth cooling device 34 are aligned in order in the orthogonal direction. The wind receiving surface of the fourth cooling device 31 is arranged on substantially the same plane as the wind receiving surfaces of the first and second cooling devices 31 and 32. The fourth cooling device 34 is, for example, an after-cooler for cooling compressed supercharged air. The filling member 35 is arranged between the fourth cooling device 34 and the second cooling device 32. The filling member 35 is arranged between the fourth cooling device 34 and the partition plate 30a. As described above, the ventilation path 30a is blocked by the first cooling device 31, the second cooling device 32, and the fourth cooling device 34. The gaps between the cooling devices are filled by the filling members 35. The ventilation path 30a may not be completely blocked.

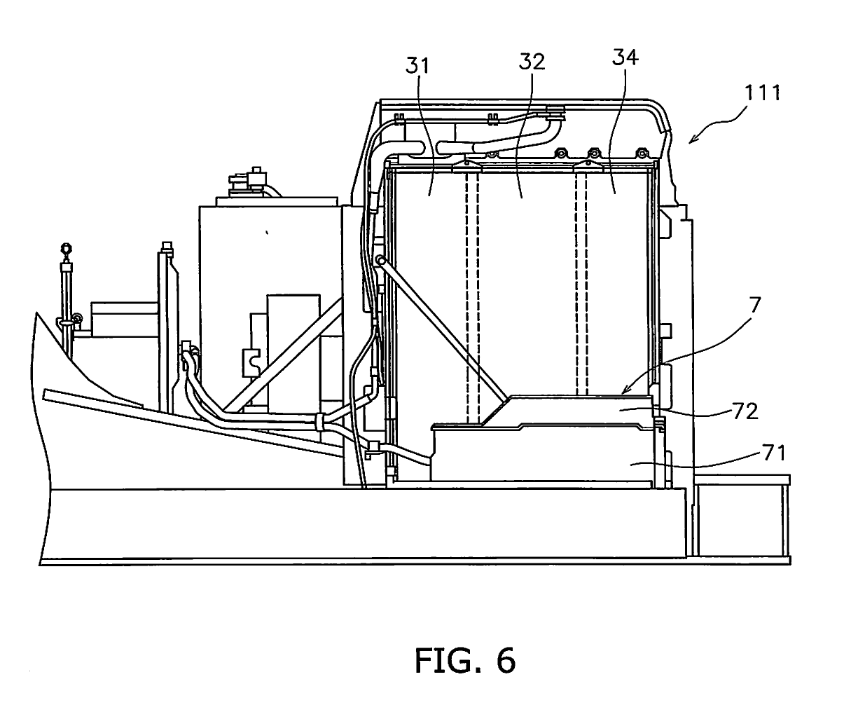

The electrical equipment 7 is arranged on the upstream side of the cooling air of the cooling unit 3. The electrical equipment 7 is cooled by the cooling medium from the first cooling device 31. The electrical equipment 7 is connected electrically to the revolving electric motor 6. FIG. 6 is a side view illustrating the inside of the engine compartment 111. As illustrated in FIG. 6, the electrical equipment 7 has the condenser 71 and the inverter 72. The condenser 71 stores electrical power generated by the revolving electric motor 6. The inverter 72 converts the electrical power generated by the revolving electric motor 6 from direct current to alternating current. The inverter 72 is arranged on the upper surface of the condenser 71.

The condenser 71 and the inverter 72 extend along the alignment direction in which the first cooling device 31 and the second cooling device 32 are aligned. The condenser 71 and the inverter 72 extend in the orthogonal direction. In the present exemplary embodiment, the condenser 71 and the inverter 72 extend in the front-back direction.

The long side of the inverter 72 is shorter than the long side of the condenser 71. The inverter 72 is shorter than the condenser 71 in the orthogonal direction. The inverter 72 is arranged further away from the first cooling device 31 in the orthogonal direction. The condenser 71 extends from the first cooling device 31 to the fourth cooling device 34 in the orthogonal direction. The inverter 72 extends from the second cooling device 32 to the fourth cooling device 34 in the orthogonal direction. The inverter 72 is arranged so as not to hinder the flow of the cooling air flowing toward the first cooling device 31.

FIG. 7 is a plan view illustrating an arrangement of the various members. As illustrated in FIG. 7, the third cooling device 33 has a first surface 331 facing the first cooling device 31 and a second surface 332 facing the opposite side of the first surface 331. The first surface 331 faces a first side (left side) in the vehicle width direction, and the second surface 332 faces a second side (right side) in the vehicle width direction.

The hydraulic fluid tank 110 is arranged on the side that the second surface 332 faces. The control valve 112 also is arranged on the side that the second surface 332 faces. The control valve 112 is configured to control the flow rate of the hydraulic fluid supplied to the hydraulic devices. The electrical equipment 7 is arranged on the side that the first surface 331 faces. The condenser 71 and the inverter 72 are arranged on the first side (left side) in the vehicle width direction and the hydraulic fluid tank 110 and the control valve 112 are arranged on the second side (right side) in the vehicle width direction relative to the cooling unit 3. The electrical equipment 7, the cooling unit 3, the control valve 112, and the hydraulic fluid tank 110 are arranged in order in the vehicle width direction.

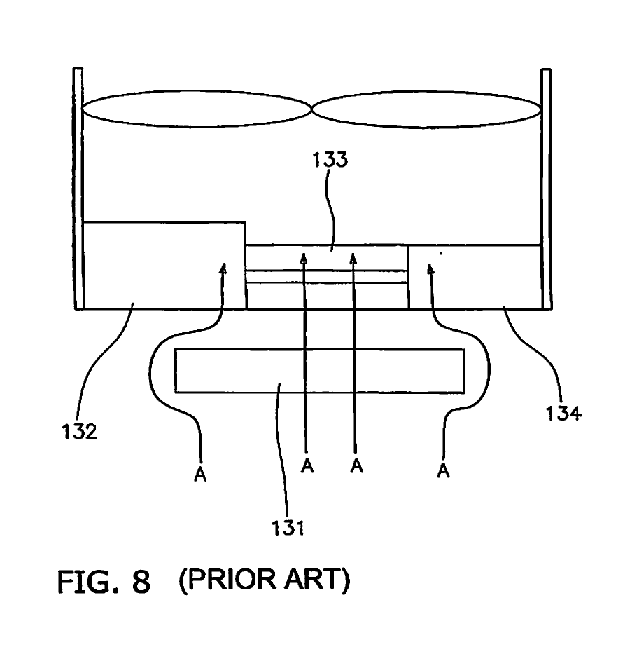

As described above, the hydraulic excavator 100 according to the above present exemplary embodiment allows for improved cooling efficiency of the cooling medium by the first cooling device 31. As illustrated in FIG. 8, the conventional electrical equipment radiator 131 is arranged separately on the upstream side of the cooling air with respect to the other radiators. As a result, the outside air flows through a region in which the electrical equipment radiator 131 is not arranged and flows downstream of the electrical equipment radiator 131 to avoid the electrical equipment radiator 131 as shown by arrows A in FIG. 8. In contrast, the first cooling device 31 is arranged as a portion of the cooling unit 3 that blocks the ventilation path 30a as illustrated in FIG. 2. As a result, the outside air flows so as to pass through the cooling devices 31 to 34 of the cooling unit 2 as shown by the arrows A in FIG. 2. Consequently, a sufficient amount of the outside air passes through the first cooling device 31 and the cooling efficiency of the cooling medium in the first cooling device 31 can be improved.

The first cooling device 31 is not positioned on the upstream side of the cooling unit 3 and is arranged as a portion of the cooling unit 3 in the ventilation path 30a. As a result, a space on the upstream side of the cooling unit 3 can be secured and maintenance of the cooling unit 3 can be facilitated. Because the first cooling device 31 is not arranged on the upstream side of the cooling unit 3, the cooling unit 3 can be arranged further toward the upstream side of the cooling air than the conventional cooling unit. Consequently, the distance between the cooling unit 3 and the cooling fan 2 can be increased and a rectifying effect of the ventilation path 30a can be improved. Because the first cooling device 31 is not arranged separately and is arranged as a portion of the cooling unit 3, the first cooling device 31 is able to be supported by a supporting member for supporting the other cooling devices 32 to 34. The need is removed for providing a separate supporting member for the first cooling device 31 as in the conventional manner.

While an exemplary embodiment of the present invention has been described above, the present invention is not limited to the exemplary embodiment and the following modifications may be made within the scope of the present invention.

For example, while the cooling unit 3 of the above exemplary embodiment has the first to fourth cooling devices 31 to 34, the present invention is not limited as such. For example, the cooling unit 3 may not include the fourth cooling device 34. The cooling unit 3 may also have another cooling device.

The order of the cooling devices in the orthogonal direction is not limited in particular to the order stated in the above exemplary embodiment.

While the present invention is applied to a hydraulic excavator in the above exemplary embodiment, the present invention may also be applied to another hybrid work vehicle, such as a wheel loader or a motor grader.

1. A hybrid work vehicle comprising:
an electric motor;
an electrical equipment connected electrically to the electric motor;
a fan for generating cooling air;
a partitioning member that forms a ventilation path for guiding the cooling air; and
a cooling unit including a first cooling device for cooling a cooling medium for cooling at least one of the electric motor and the electrical equipment, and a second cooling device arranged laterally to the first cooling device, the cooling unit being arranged to block the ventilation path.

2. The hybrid work vehicle according to claim 1, further comprising
a third cooling device arranged on the downstream side of the cooling air with respect to the first cooling device;
the first cooling device including a first inlet arranged in either of an upper part and a lower part of the first cooling device and facing the upstream side of the cooling air, and a first outlet arranged on the other of the upper part and the lower part of the first cooling device and facing the upstream side of the cooling air; and
the third cooling device including a second inlet arranged in either of an upper part and a lower part of the third cooling device and facing the downstream side of the cooling air, and a second outlet arranged on the other of the upper part and the lower part of the third cooling device and facing the downstream side of the cooling air.

3. The hybrid work vehicle according to claim 1, wherein
the electrical equipment is arranged on the upstream side of the cooling air with respect to the cooling unit;
the electrical equipment includes a condenser for accumulating electrical power generated by the electric motor, and an inverter arranged on top surface of the condenser and converting the electrical power for direct current to alternating current;
a long side of the inverter is shorter than a long side of the condenser; and
the inverter is arranged in a direction further away from the first cooling device in the long side direction of the inverter.

4. The hybrid work vehicle according to claim 1, further comprising
a hydraulic fluid tank that stores hydraulic fluid;
the third cooling device being an oil cooler for cooling the hydraulic fluid;
the third cooling device including a first surface facing the first cooling device and a second surface facing the opposite side of the first surface; and
the hydraulic fluid tank being arranged on the side the second surface faces.

5. The hybrid work vehicle according to claim 4, further comprising
a control valve arranged on the side the second surface faces and controlling a flow rate of the hydraulic fluid.

6. The hybrid work vehicle according to claim 1, wherein
the cooling unit further includes a filling member arranged between the first cooling device and the second cooling device.

7. The hybrid work vehicle according to claim 1, wherein
the cooling unit further includes a fourth cooling device arranged laterally to the second cooling device.

8. The hybrid work vehicle according to claim 1, wherein
the second cooling device is an engine radiator for cooling a cooling medium for the engine.

9. The hybrid work vehicle according to claim 2, wherein
the electrical equipment is arranged on the upstream side of the cooling air with respect to the cooling unit;
the electrical equipment includes a condenser for accumulating electrical power generated by the electric motor, and an inverter arranged on top surface of the condenser and converting the electrical power for direct current to alternating current;
a long side of the inverter is shorter than a long side of the condenser; and
the inverter is arranged in a direction further away from the first cooling device in the long side direction of the inverter.

10. The hybrid work vehicle according to claim 9, further comprising
a hydraulic fluid tank that stores hydraulic fluid;
the third cooling device being an oil cooler for cooling the hydraulic fluid;
the third cooling device including a first surface facing the first cooling device and a second surface facing the opposite side of the first surface; and
the hydraulic fluid tank being arranged on the side the second surface faces.

11. The hybrid work vehicle according to claim 10, further comprising
a control valve arranged on the side the second surface faces and controlling a flow rate of the hydraulic fluid.

12. The hybrid work vehicle according to claim 11, wherein
the cooling unit further includes a filling member arranged between the first cooling device and the second cooling device.

13. The hybrid work vehicle according to claim 12, wherein
the cooling unit further includes a fourth cooling device arranged laterally to the second cooling device.

14. The hybrid work vehicle according to claim 13, wherein
the second cooling device is an engine radiator for cooling a cooling medium for the engine.
